(19) United States
(12) Patent Application Publication
(10) Pub. No.: US 2008/0315455 A1
(43) Pub. Date: Dec. 25, 2008

(54) METHOD OF COOLING MATERIAL USING AN EXTRUDER SCREW CONFIGURED FOR IMPROVED HEAT TRANSFER

(76) Inventor: Chris J. Rauwendaal, Auburn, CA (US)

Correspondence Address: Patent Law Office of Larry Guernsey, P.O. Box 720247, San Jose, CA, 95172-0247, US

(21) Appl. No.: 12/177,940

(22) Filed: Jul. 23, 2008

Related U.S. Application Data
(62) Division of application No. 11/101,973, filed on Apr. 8, 2005, now abandoned.

(51) Int. Cl. B01F 15/06; B29C 47/38

(52) U.S. Cl. 264/211.21; 366/133

(57) ABSTRACT

A method of cooling material in a screw extruder having a barrel including providing at least one extruder screw having a central shaft. The at least one extruder screw includes at least one screw flight including at least one interruption in the screw flight to form at least one discontinuity by which a portion of the screw flight is circumferentially displaced from the remainder of the screw flight. Material is turned from near the central shaft outwards toward the inner surface of the screw extruder barrel through the at least one discontinuity.

The present application is a divisional and claims priority from co-pending U.S. non-provisional application Ser. No. 11/101,973 filed Apr. 8, 2005, and to provisional application 60/565,091, filed Apr. 22, 2004, both applications by the present inventor, and are commonly assigned.

### TECHNICAL FIELD

The present invention relates generally to screw extruders and machinery for fabrication of extruded parts.

### BACKGROUND ART

Heat transfer is a critical issue in most polymer extrusion operations. In plasticating extrusion the objective is to add the right amount of heat to melt the polymer and to achieve the desired melt temperature. In some extrusion operations, however, the objective is to remove heat from the polymer. This is the case in tandem foam extrusion lines where the secondary extruder is used to cool down the mixture of polymer melt and blowing agent. Cooling extruders reduce the polymer melt temperature by a substantial amount, about 100° C., to achieve a melt consistency that is conducive for foaming

As the foam extrusion industry faces pressure to move from CFC (chlorofluorocarbon) blowing agents to HCFC (hydrochlorofluorocarbon) to nitrogen and carbon-dioxide (CO₂), the cooling capacity becomes more critical. CO₂ is less of a viscosity depressant than most HCFC blowing agents. As a result, with CO₂ more viscous heating occurs in the cooling extruder and more effective cooling is required to achieve the same reduction in melt temperature.

Cooling screws have to be designed to remove heat efficiently from the gas-laden melt (GLM) while, at the same time, the viscous heat generation in the GLM has to be as low as possible. Generally, cooling screws have a large diameter (about 25% larger than the primary extruder), multiple flights, large helix angle, and deep channels. Cooling screws operate at low screw speed to minimize viscous dissipation. FIG. 1 shows a typical cooling screw.

The viscous heating is determined by the product of the melt viscosity (η) and shear rate (\dot{γ}) squared. The shear rate can be approximated by the circumferential velocity divided by the channel depth of the screw. For a power law fluid with consistency index m and power law index n the viscous heating per unit volume (qᵥ) can be expressed as:

$${q}_{v} = {m ( \frac{π DN}{H} )}^{n + 1} \qquad ( 1 )$$

Variable D represents the diameter, N screw speed, and H the channel depth. A low screw speed (N) and a large channel depth (H) are beneficial in keeping the viscous dissipation low. Further, low values of the consistency index and power law index will result in low viscous dissipation. The consistency index is largely determined by the polymer; it also depends on temperature and the type and amount of blowing agent.

The power consumption (Z) is obtained from the product of qᵥ and the volume of the polymer melt. If the volume is approximated by πDHL the power consumption becomes:

$$Z = \frac{{m}_{r} exp [ a ( {T}_{r} - T ) ] {L ( π D )}^{n + 2} {N}^{n + 1}}{{H}^{n}} \qquad ( 2 )$$

The consistency index is made temperature dependent using an exponential dependence of temperature with a temperature coefficient of a. The consistency index mᵣ is the value at reference temperature Tᵣ.

For a realistic determination of melt temperatures we have to consider both viscous dissipation and conductive heat transfer through the barrel. When the screw is cooled we have to consider heat transfer through the screw as well. If the conductive heat transfer is constant, the temperature gradient can be expressed as:

$$\frac{d T}{d x} = {B}_{1} {e}^{a ( {T}_{r} - T )} - {B}_{2} \qquad ( 3 )$$

B₁ represents the contribution of viscous heating.

$${B}_{1} = \frac{{{m}_{r} ( π D )}^{n + 2} {N}^{n + 1}}{{H}^{n} {C}_{p} \dot{M}} \qquad ( 4 )$$

where Cₚ is the specific heat and \dot{M} the mass flow rate.

B₂ represents the contribution of conductive heat transfer.

$${B}_{2} = \frac{{q}_{c} π D}{{C}_{p} \dot{M}} \qquad ( 5 )$$

The units of B₁ and B₂ are [° C./m]; these are units of temperature gradient. Variable q_{c} is the heat flux through the barrel wall. Subject to boundary condition T(x=0)=T₀ the differential equation can be solved. The solution can be written as:

$$T ( x ) = \frac{1}{a} ln [ ( {e}^{{aT}_{0}} - \frac{{B}_{1}}{{B}_{2}} {e}^{{aT}_{r}} ) {e}^{- {aB}_{2} x} + \frac{{B}_{1}}{{B}_{2}} {e}^{{aT}_{r}} ] \qquad ( 6 )$$

The melt temperature is independent of distance when the conductive heat transfer equals the viscous dissipation. This limiting heat transfer q_{c0} can be expressed as:

$${q}_{{c}^{0}} = \frac{{{m}_{r} ( π DN )}^{n + 1} exp [ a ( {T}_{r} - T ) ]}{{H}^{n}} \qquad ( 7 )$$

When q_{c}>q_{c0} the melt temperatures will reduce with axial distance; when q_{c}<q_{c0} the melt temperature will increase with axial distance. Obviously, in cooling extruders the actual heat transfer has to be greater than the limiting heat transfer. It is important to note that the limiting heat transfer is dependent on the actual melt temperature. As the melt is cooled along the extruder the effective viscosity will increase as the melt temperature is lowered. This means that the viscous dissipation will increase as the melt temperature reduces. As a result, the cooling will become less efficient as the melt progresses along the extruder. Therefore, increasing the length of the extruder does not necessarily improve the cooling capacity.

Expression 6 is valid for situations where the heat transfer is constant. If the barrel temperature is maintained at constant temperature the heat transfer rate will change as the melt cools down. We can analyze this situation by analyzing small length increments and adjusting the heat transfer rate at the start of each new increment. FIG. 2 shows the axial temperature profile for a 200-mm cooling screw for six screw speeds, 3, 6, 12, 18, 24, and 30 rev/min. The barrel temperature is maintained at 100° C. at a specified distance from the barrel internal diameter. The inlet temperature of the melt is 225° C.

At the start of the cooling process the melt temperature reduces quickly; however, the rate of cooling reduces along the length of the extruder. This is due to a reduced temperature gradient in the barrel and an increased level of viscous dissipation as the melt cools down. The effect of viscous dissipation is clearly shown by the increase in melt temperature with screw speed. FIG. 2 clearly shows the benefit of operating the cooling extruder at low screw speed.

The expressions developed describe the axial melt temperature profile as long as the heat flux through the melt equals the heat flux through the barrel wall. The expressions are essentially based on a finite volume approach. In order to the determine whether the heat flux through the melt is high enough to achieve efficient cooling we have to perform a 3D non-isothermal flow analysis to determine the cross section melt temperature distribution.

One of the main challenges in cooling is the low thermal conductivity of the melt. As a result, the cooling at the barrel surface affects only a relatively thin melt layer. This means that the outer recirculating melt layer is cooled effectively. However, the inner recirculating region is insulated from the barrel surface by a thick melt layer and the temperature in this region tends to be substantially higher than the barrel temperature. The insulated inner melt region leads to inefficient cooling particularly in screws with large channel depth.

Earlier studies on melt temperature distribution in extruder screws have found that high melt temperatures in the inner recirculating region are inherent in screw extruders. FIG. 3 shows the temperature distribution in a 60-mm extruder screw running at 20 rpm with a fractional melt (MI=0.2) HDPE. This figure indicates that non-uniform cooling can result in highly non-uniform melt temperatures.

FIG. 3 shows that the melt in the outer region of the channel is relatively cool while the melt in the center region is relatively hot. The inner recirculating region is insulated from the screw and barrel surface. As a result, heat removal from this region is very ineffective and this results in high melt temperatures in this region.

In order to improve cooling it is necessary to move melt from the inner region to the outer region. In the past, this was done by machining slots in the flights of the screw; a large number of slotted flight geometries have been used. However, slots generally do not achieve a very effective redistribution of the melt. Fogarty developed a screw with windows in the flights; this screw is called the Turbo screw. The windows are relatively large and allow melt to transfer from one channel to an adjacent channel improving heat transfer.

A related concern in extruder design is the mixing of materials. A paper entitled “Backmixing in Screw Extruders,” 58^{th} SPE ANTEC (Annual Technical Conference of the Society of Plastics Engineers), Orlando, Fla., 111-116, Chris Rauwendaal and Paul Gramann (2000)” addressed the problem of backmixing in screw extruders. An “inside-out” mixing screw is disclosed which uses flights which are offset so that the material in the center region is cut by the offset flight and then pushed to the screw and barrel surfaces by the normal pressure gradients that occur at the flight flank. Fluid from the center region is cut by the offset flight and pushed to screw surface at the pushing side of the flight and to the barrel surface at the trailing side of the flight, which produces improved backmixing.

The paper describing the “inside-out mixer” helps to improve back-mixing, but does not directly address the problems of heat-transfer. In particular, a typical mixer is only 1-3D long, which is insufficient to make significant improvement in heat-transfer. In addition, for typical plasticating extruders the flight height is about 0.05D-0.10D and typical flight width in plasticating extruders is 0.10D. These flight heights and widths do not allow for significant improvement in heat transfer. Also, the number of flights used is not discussed.

Thus there is a need for an extruder screw which has improved heat-transfer characteristics.

### DISCLOSURE OF INVENTION

Accordingly, it is an object of the present invention to provide an extruder screw which has improved heat transfer.

An object of this invention is to provide an extruder screw which has improved mixing capability.

And another object of the invention is to provide an extruder screw which produces a narrower residence time distribution.

A further object of the present invention is to provide an extruder screw which allows more control over the stock temperatures and more overall process control.

An additional object of the present invention is to provide an extruder screw which allows higher throughputs to be achieved by better mixing and heat transfer.

Yet another object of the present invention is to provide an extruder screw which reduces the time required from change from material A to B.

Briefly, one preferred embodiment of the present invention is an extruder screw for a screw extruder having a central shaft and a number of screw flights arranged upon the central shaft. At least one of the screw flights including at least one discontinuity which is an interruption in said screw flight by which one or more portions of the screw flight is offset circumferentially from the remainder of the screw flight. Also disclosed is a screw extruder including a screw having at least one discontinuity, a method of cooling material in a screw extruder, and a method of extruding material from a screw extruder while cooling material within the extruder.

An advantage of the present invention is that the extruder can provide improved heating of the polymer melt (or whatever material is being extruded).

Another advantage of the present invention is that the extruder can provide improved mixing, both cross sectional and longitudinal mixing.

And another advantage of the present invention is that the extruder can produce a narrower residence time distribution.

A further advantage of the present invention is that the extruder can provide higher throughput in the extrusion process.

A yet further advantage is that the extruder can reduce the product change-over time when changing form material A to B.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 shows a side elevation view of a typical extruder screw of the prior art;

FIG. 2 shows a graphic of the axial temperature profile for a 200-mm cooling screw for six screw speeds, 3, 6, 12, 18, 24, and 30 rev/min.;

FIG. 3 shows a graph of the temperature distribution in a 60-mm extruder screw running at 20 rpm with a fractional melt (MI=0.2) HDPE;

FIG. 4 shows a side elevational view with partial cut-away of a screw extruder including a high heat transfer (HHT) screw of the present invention;

FIG. 5 shows a detail side elevational view of a high heat transfer (HHT) screw of the present invention; and

FIGS. 6-8 show cross-sectional views of screw channels showing the change in heat distribution of material as it passes through a discontinuity in a high heat transfer (HHT) screw of the present invention.

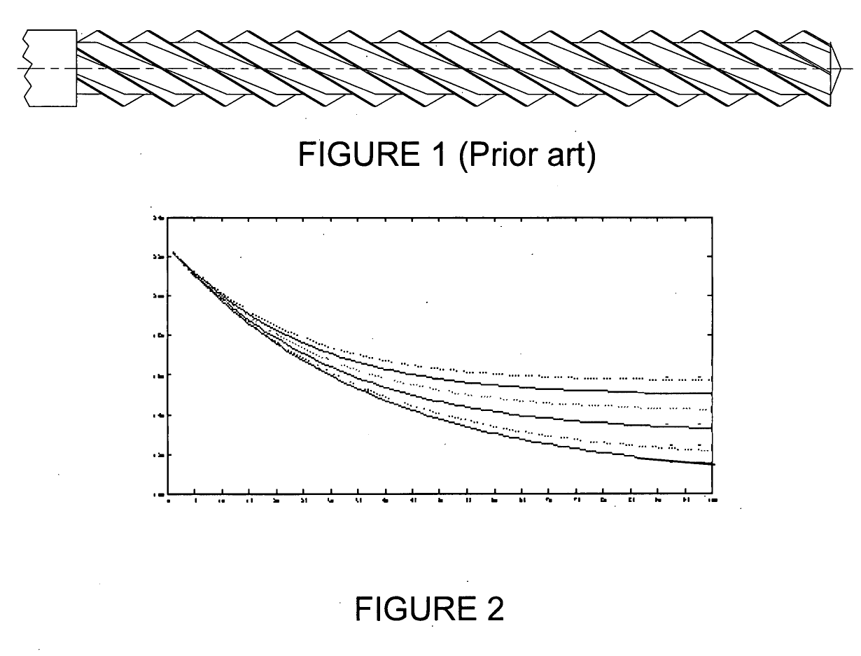

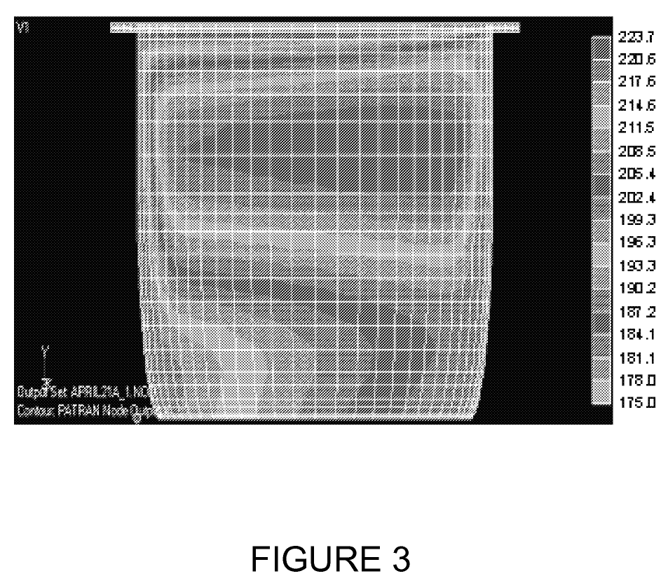

### BEST MODE FOR CARRYING OUT THE INVENTION

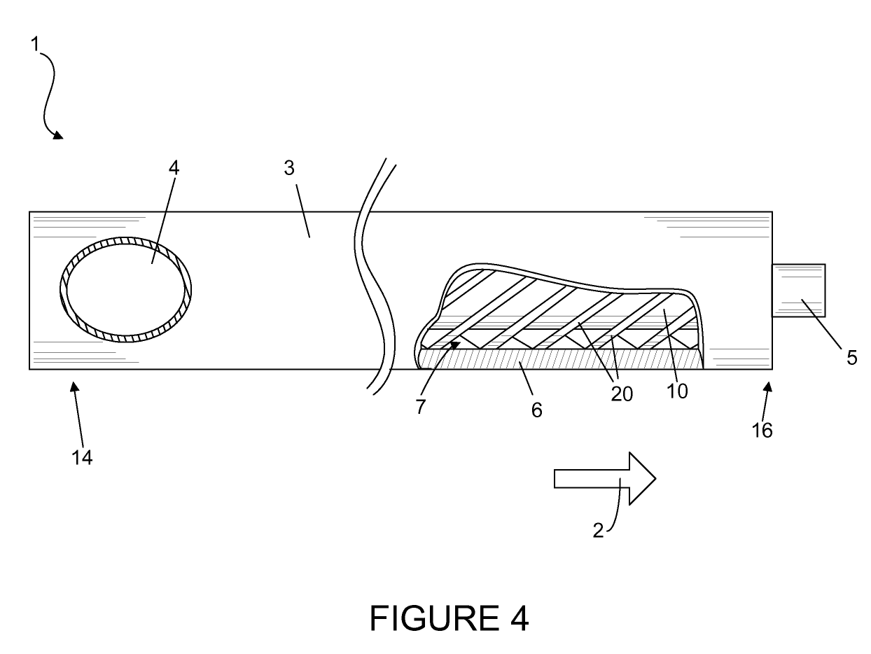

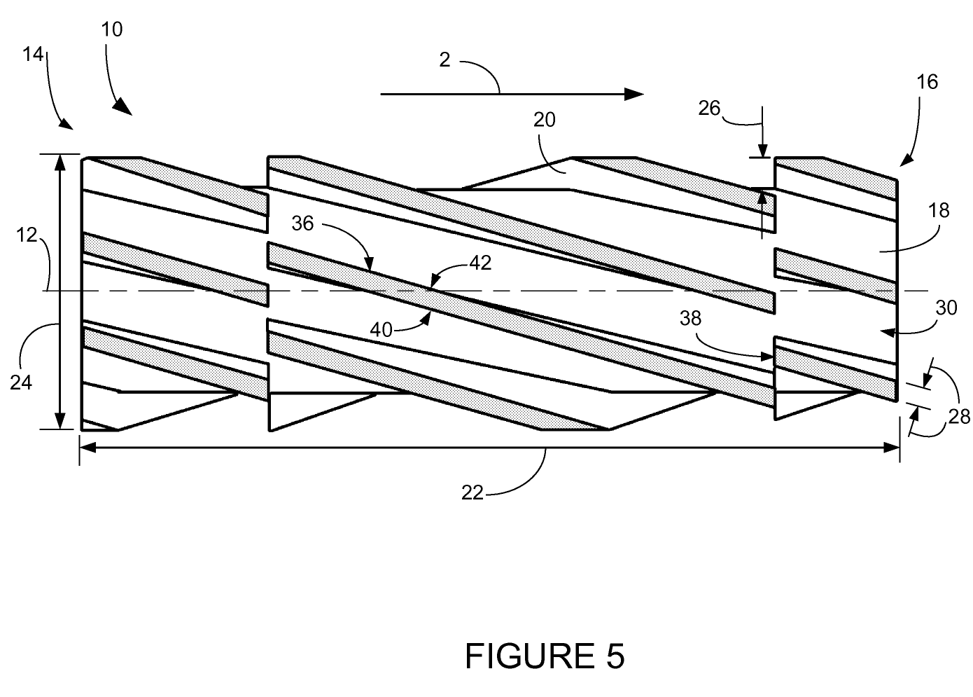

The present invention is an extruder screw improved for heat transfer or “high heat transfer (HHT) screw”, which is shown in FIGS. 4 and 5, and will be designated by the element number 10.

FIG. 4 shows the extruder screw 10 mounted in a screw extruder 1. The screw extruder 1 has an input end 14 and an output end 16. Generally, for convenience of reference, the terms “downstream” shall refer to those ends closest to the output portion of the screw extruder and the term “upstream” shall refer to those ends farthest away from the output. The downstream direction is indicated by a large arrow 2, which shows the direction of material flow. The screw extruder 1 has a barrel 3. The input end 14 includes an input hopper 4 for feeding in material, and an extrusion die 5 on the output end 16. A portion of the barrel 3 has been cut away to show the barrel wall 6, and an inner bore 7. Positioned within the bore 7 is the extrusion screw 10 having screw flights 20. Although this version of the preferred embodiment has a single screw, it is to be understood that the screw extruder could contain two or more screws.

FIG. 5 shows the screw 10 in more detail. The screw has a central longitudinal axis 12, and also has an input end 14 and an output end 16. Again, the downstream direction is indicated by a large arrow 2, which shows the direction of material flow. The high heat transfer (HHT) screw 10 has a central shaft 18 and a number of flights 20.

The high heat transfer (HHT) screw 10 is defined as having a length (L) 22. A screw diameter (D) 24 is defined as the tip to tip distance between flights 20 when positioned on opposite sides of the central shaft 18. In FIG. 8, no attempt has been made to depict the ratios of L to D realistically, for, as shall be discussed below, the high heat transfer (HHT) screw 10 preferably is closer to 30D long or longer, and it is anticipated that some screws maybe be as long as 80D.

The flights 20 of the high heat transfer (HHT) screw 10 are shown, and in this version of the preferred embodiment there are six flights which are positioned at regular intervals around the circumference of the central shaft 18. It is to be understood that other numbers of flights such as four, etc. may be used, and their positions around the circumference of the shaft 18 is likewise variable. It is desirable, however, that the flights 20 be symmetrically arranged around the shaft 18 circumference in order that the forces on the shaft 18 are balanced and deflection is minimized.

The distance between the central shaft 18 and the tips of the flights 20 will define the flight height (H) 26. Additionally, the width of the tip of the flight (w_{f}) will be designated as 28. For purposes of this discussion, the screw channel 30 will be described as the volume between the screw central shaft 18, between the screw flights 20, and extending outward the height 26 of the screw flights 20. It is understood that in practice, the depth of the screw channel may be conceived of as extending outward to the inner surface of the barrel of the screw extruder (not shown), but for this discussion, the definition will be simplified as discussed above.

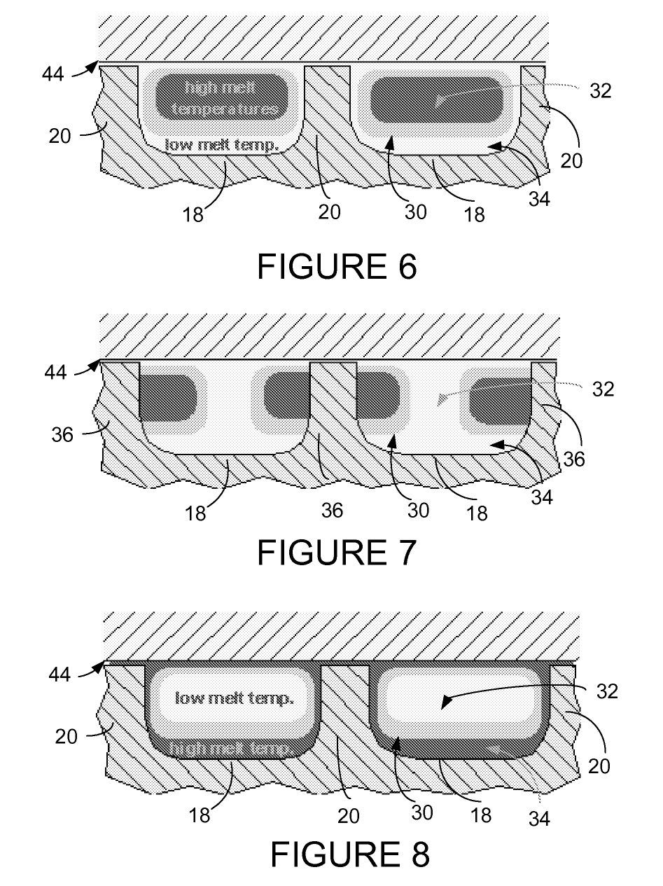

Referring now also to FIGS. 6-8, this high heat transfer (HHT) screw 10 is designed to achieve an effective exchange of material from the inner region 32 of the screw channel 30 to the outer region 34 and vice versa. The exchange is achieved by starting a discontinuous flight 36 in the middle of the channel 30, creating what will be termed a discontinuity 38. Put another way, the discontinuous flight has a portion that is displaced to some degree around the circumference of the central shaft, or “circumferentially displaced”, as the term shall be used in this application. The discontinuous flight 36 splits the hot region; at the trailing side of the flight 40 the hot region moves to the surface of the extruder barrel 44 while at pushing side of the flight 42 the hot material moves to the surface of the central screw shaft 18. The net effect of the introduction of the discontinuous flight 36 is that hot material in the inner region 32 is forced to the outer region 34 and, at the same time, cold material from the outer region 34 is forced to the inner region 32. This is illustrated in FIGS. 6-8. FIG. 6 shows the melt temperature distribution in the channel of a conventional screw. FIG. 7 shows the change in melt temperature distribution when a discontinuous flight 36 is introduced in the center of the channel 30. FIG. 8 shows the melt temperature distribution after introduction of the discontinuous flight 36.

FIGS. 6-8 illustrate how the melt from the inner region 32 is forced to the outside 34 and the melt from the outside region 34 to the inside 32.

The high heat transfer (HHT) screw 10 was first applied to a tandem foam extrusion line for PS foam board. The melt index of the PS was 2.5 g/10 min and the blowing agent was a mixture of two HCFCs. The cooling extruder is a 200-mm extruder with a length to diameter ratio of 31:1. The high heat transfer (HHT) screw 10 replaced a commercial cooling screw supplied by Battenfeld. The throughput was 700 kg/hr and the screw speed was 10 rpm. The cooling capacity with the high heat transfer (HHT) screw improved 25% to 30% compared to the old screw. The product expansion was very uniform and significantly better than with old screw. The uniform expansion is most likely due to the more uniform temperature distribution within the material.

The effectiveness of conventional cooling screws is limited by the fact that the melt in the inner region of the channel is insulated from the barrel surface. Cooling can be improved significantly by using a screw geometry that achieves effective mass transfer from the inner region 32 to the outer region 34 and vice versa. A new screw geometry has been developed which forces high temperature melt in the inner region 32 of the channel 30 to the barrel surface 44. This high heat transfer (HHT) screw 10 has been used in polystyrene foam extrusion to improve the cooling capacity of the secondary extruder. The high heat transfer (HHT) screw 10 improved the cooling capacity by 25% to 30% relative to the existing screw.

In order to implement this improvement, the changes have been made, so that the high heat transfer (HHT) screw 10 is in the range of 10D-80D long, and the high heat transfer (HHT) screw 10 geometry extends over the majority of the length of the screw 10. A typical mixer of the prior art, including the “inside-out extruder” discussed above, is only 1-3D long.

In addition, in the high heat transfer (HHT) screw 10 of the present invention, the flight height 26 is quite large, about 0.10D-0.30D. In typical plasticating extruders of the prior art, that might use the “inside-out mixer discussed above, the flight height is about 0.05D-0.10D.

The high heat transfer (HHT) screw 10 uses narrow flights 20, as the flight width 28 is between 0.01D-0.08D. Typical flight width in plasticating extruders of the prior art, including the “inside-out mixer” discussed above, is 0.10D.

The high heat transfer (HHT) screw 10 uses multiple flights, preferably four to eight parallel flights.

There may be considerable variation in the number of discontinuities included in the high heat transfer (HHT) screw 10, which is in the range of 2 to 20.

It should also be noted that the heat transfer capability for cooling the polymer melt can be beneficially used for heating the polymer melt as well. The problem with limited heat transfer is more acute in large diameter extruders. As a result, barrel temperatures tend to have little effect on the process with large extruders. However, with the HHT technology the effect of barrel temperatures on the process can be enhanced significantly. It is expected that there are benefits in smaller extruders as well although these are likely to be less substantial.

While various embodiments have been described above, it should be understood that they have been presented by way of example only, and not limitation.

What is claimed is:

1. A method of cooling material in a screw extruder having a barrel having an inner surface, and a central shaft, said method comprising:
A) providing a screw extruder having a screw with a plurality of screw flights, where at least one screw flight creates at least one discontinuity; and
B) passing material through said at least one discontinuity.

2. A method of cooling material in a screw extruder having a barrel having an inner surface, and a central shaft, said method comprising:
turning material from near the central shaft outwards toward said inner surface of said barrel by passing material though at least one discontinuity.

3. The method of cooling material of claim 2, wherein:
said discontinuity is an interruption in said screw flight by which a portion of said screw flight is circumferentially displaced from the remainder of said screw flight.

4. The method of cooling material of claim 3, wherein:
said screw flights are symmetrically arranged upon said central shaft.

5. The method of cooling material of claim 3, wherein:
each of said screw flights includes 2-20 discontinuities.

6. A method of extruding material from a screw extruder in which material is cooled, said method comprising:
A) providing a screw extruder including a barrel having input and output ends, a bore defining an inner surface, and an extrusion die at said output end;
B) providing at least one extruder screw positioned within said bore, each screw including a central shaft, said at least one extruder screw further having at least one screw flight including at least one interruption in said screw flight to form at least one discontinuity by which a portion of said screw flight is circumferentially displaced from the remainder of said screw flight, by which material is turned from near the central shaft outwards toward said inner surface of said barrel by through said at least one discontinuity;
C) introducing extrusion material into said input end of said barrel;
D) rotating said at least one screw to force said material through said at least one discontinuity; and
E) conveying said material towards said extrusion die at said output end to be shaped.
